(19) United States
(12) Patent Application Publication
(10) Pub. No.: US 2004/0051729 A1
(43) Pub. Date: Mar. 18, 2004

(54) Aural user interface

(76) Inventor: George R. Borden IV, Portland, OR (US)

Correspondence Address: Kevin L. Russell, Chernoff, Vilhauer, McClung & Stenzel, LLP, 1600 ODS Tower, 601 S.W. Second Avenue, Portland, OR, 97204-3157, US

(21) Appl. No.: 10/627,345

(22) Filed: Jul. 25, 2003

Related U.S. Application Data
(60) Provisional application No. 60/399,013, filed on Jul. 25, 2002.

(51) Int. Cl. G09G 5/00

(52) U.S. Cl. 345/727

(57) ABSTRACT

An aural user interface suitable for use with hierarchical structures.

This application claims the benefit of U.S. application Ser. No. 60/399,013 filed Jul. 25, 2002 entitled Aural User Interface.

### BACKGROUND OF THE INVENTION

The present invention relates to aural user interfaces.

Personal systems that offer ubiquitous access to networked data and devices are becoming more prevalent. As they begin to offer better services, people will desire to use them in ever more challenging environments. Current user interfaces are typically severely limited for use in a variety of different situations. For example, visual interfaces are not suitable for use concurrently with other visually intensive activities such as driving. Also, speech recognition interfaces are not suitable for use concurrently with other speech tasks or while in a noisy environment. Furthermore, such interfaces often require most of the cognitive resources of the user in order to accomplish even simple tasks.

Mobile devices, such as compact disc players and limited memory MP3 players, have traditionally carried a single album of approximately 20 songs. With a limited number of available songs and the user's familiarity with the order of the songs on the album, the user may relatively straightforwardly navigate through the menu structure of the player to the desired song. With the advent of MP3 players having large amounts of memory, it is now possible to store thousands of songs from different artists and albums on a single MP3 player. With such a large number of songs, it becomes problematic for the user to skip to the 567^{th} song of the album. To assist the user in confronting this problematic issue, many such devices offer a visual interface to permit simplified navigation. Unfortunately, while such a visual interface may be suitable while sitting at a desk, it is not suitable while jogging or otherwise driving a vehicle. Under such circumstances the user interface is rendered essentially useless and at worst dangerous.

The use of non-speech sounds has the potential to add functionality to computer interfaces. For example, when selecting an icon on the desktop of a Windows (tm) based computer system a clicking sounds may be heard to indicate that the icon has been selected. Sounds are also used for other auditory alerts to users. While of some benefit, many users tend to find these bleeps, buzzes, and clicks to be distracting and irritating. Accordingly, the use of audio based interfaces must be carefully employed if to be of any value to uses.

A paper entitled “The SonicFinder, An Interface That Uses Auditory Icons” by Gaver introduced the concept of utilizing everyday sounds with specific actions in a user interface to provide a metaphor to which users can attach meanings. Normally such an approach tends to be useful in the context of improving the ease of use of graphical user interfaces. While of curious interest, the system has the tendency to result in a plethora of different sounds, one for each event, that in the end tends to be distracting and confusing to the user.

In addition to graphical based systems, there are other audio-based system that do not include visual components. Such non-graphical based systems tend to be employed in phone based menu systems. While there are many different styles, Resnick in a paper entitled “Relief From The Audio Interface Blues: Expanding The Spectrum Of Menu, List, and Form Styles” suggests that there is no single style that fits every prospective application and user population.

### BRIEF DESCRIPTION OF THE DRAWINGS

FIG. 1 is a flow diagram of one embodiment of the system.

FIG. 2 illustrates a hierarchical data structure.

### DETAILED DESCRIPTION OF THE PREFERRED EMBODIMENT

The present inventor considered the phone-based audio interface domain and came to the realization that phones include to many small buttons to be easily used. In addition, the audio based options of phones tend to be somewhat limited and require knowledge of which buttons, of the myriad of available buttons, should be depressed. In many cases a typical phone menu system does not have any abstraction between the button being pressed (e.g., “1”) and the action that the user wishes to accomplish (e.g., “account balance”). In contrast, a system where an abstraction exists between pressing the button and the action, would include for example, pressing “1” means to move to the previous item, pressing “2” means to move to the next item, and “3” means to select the item. Unfortunately, when implemented on a phone, such an abstraction tends to confuse the user of the phone by requiring them to remember the method of using the system. Additionally, the proper use of the system would need to be explained at the beginning of the system's introduction, thereby wasting the user's time and causing frustration.

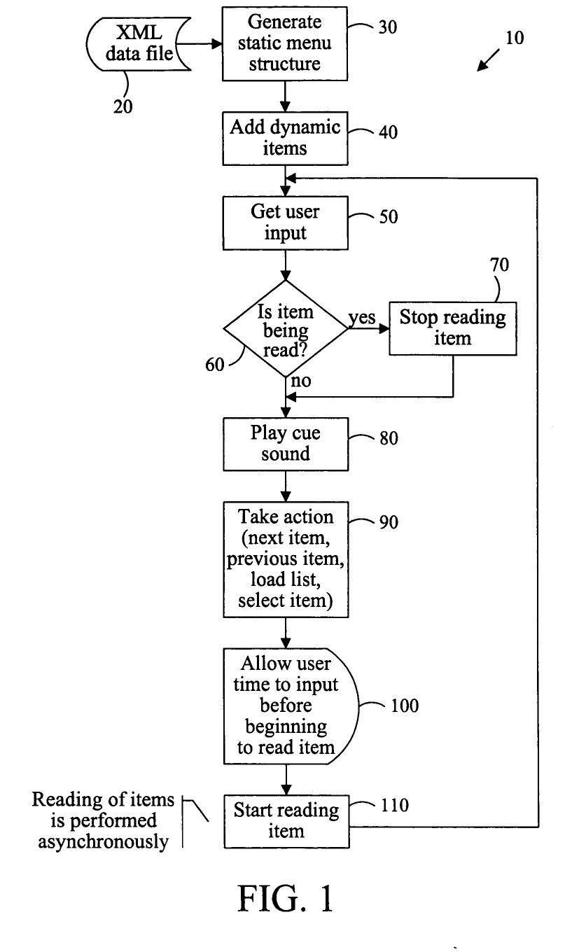

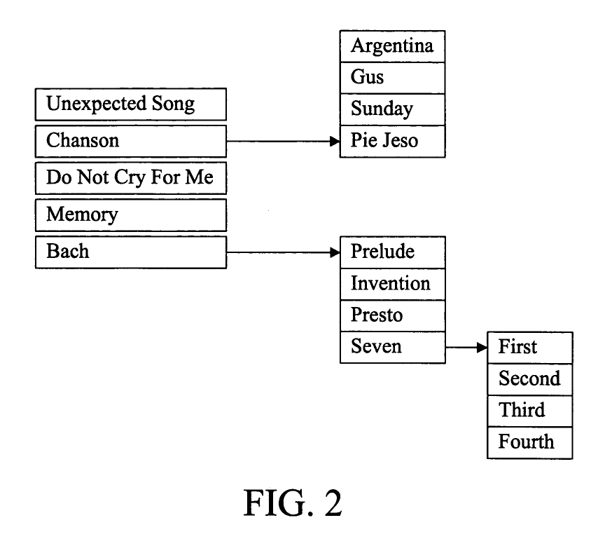

Referring to FIG. 1, in an audio based interface for a device 10, it is desirable to impose a low cognitive strain on the user. The audio interface is preferably included on a small device, such as a ring, ear mounted device, etc., and operated by manual user input and in turn provides aural output. The low cognitive strain on the user is desirable for multi-tasking situations, such as driving and walking. The data for the device may be provided as a XML data file 20, or any other suitable data file. Based upon the XML data file 20 the device 10 may arrange the data in a hierarchal manner 30, as illustrated in FIG. 2. The hierarchal arrangement of data is useful in those situations where there is potentially a large amount of different data, such as information or music, that is selectable by the user. The hierarchal arrangement permits the user to select a relatively small set of data from within the hierarchal structure and scan through the data of a selected set, which avoids in many cases the need to scan through a relatively large set of data. The system may likewise add dynamic items 40.

After arranging the data in some manner, the device 10 accepts user input 50 for navigation among the hierarchical data. The user input may include four separate inputs, namely, up, down, in (select), and out (deselect). Any number of inputs may be used, as desired. When the user is within a set of data, normally arranged as a list, the up and down inputs permit the user to move up and down, respectively, the ordered list of data. For example, the user may move from the third item in a list to the fifth item in the list by selecting the down input twice. While the user is within a set of data, the user may select another set of data “lower” within the hierarchical structure by moving to an appropriate item and selecting the “in” input. Conversely, while the user is within a set of data, the user may select another set of data “higher” within the hierarchical structure by moving to an appropriate item and selecting the “out” input. Depending on the design, the user may not need to move to an appropriate item within the list to move lower or higher, but rather merely select the “in” or “out” inputs for navigation.

In the preferred system, the up and down inputs are preferably arranged in such a manner as to allow continuous movement of one finger on a hand for operation. In this manner, the up and down inputs may be operated by movement in a single linear direction. A couple types of suitable inputs are a rocker switch with a button in the middle or a dial/button combination similar in nature to a scroll mouse, while others may likewise be used. The in and out inputs are preferably offset from the up and down buttons to reduce the likelihood of accidental activation of those buttons, which could result in significant user confusion. While navigation using the selected set of buttons is advantageous, additional aural clues may be included to assist the user.

After the user provides an input 50, the system checks to see if the data item is currently being read (e.g., music being played) at block 60. In the event that an item is being currently read, and the user has activated an input, it is apparent that the user desires to select another item. Accordingly, if the item is being read then the system stops reading the item at block 70. The system then provides an aural cue sound at block 80 to the user. The sound of the aural cue is preferably related to the hierarchical structure of the data.

When the user selects the up or down inputs, the system may provide an aural cue, such as “next item”. This provides an indication to the user that the selected item has changed.

When the user has reached the top or bottom of a list, the system may provide an aural cue, such as “no more items in list”. This provides an indication to the user of the extent of the list. Upon this occurrence, the top or bottom items, respectively, in the list may be automatically played, if desired.

When the user has selected the in input the system may provide an aural cue, such as “entered new list”. This provides an indication to the user that a lower list has been selected.

When the user has selected the out input, the system may provide an aural cue, such as “exited current list”. This provides an indication to the user that a higher list has been selected. It is noted that the audio cue for “in”, “out”, “next item” either up or down, may be different to further assist the user in differentiation.

To assist the user in determining the current location within a list, the “next item” aural cue may be provided with a variable frequency to permit the user to know their approximate location within the list. For example, a high pitched frequency may indicate that the user is toward the top of the list, while a low pitched frequency may indicate that the user is toward the bottom of the list. In addition, the frequency may give some indication of the size of the list. For example, a high pitched frequency may indicate that the list is relatively large, given that there is are other items associated with lower frequencies. With the variable frequencies, an experienced user may achieve a high navigational efficiency.

After providing the aural cue 80, the system executes the action 90 desired by the user, such as moving up, down, in, or out. In the event that the system is at its highest level then the out input may not be functional. In the event that the system is at its lowest level then the in input may not be functional. In the event that the currently selected item is at the top or bottom of a list, then the up and down inputs may not be functional, respectively.

After executing the action desired by the user, if available, then the system preferably permits time to elapse 100 before playing the selected item 110. In the event that the user selects another input during the elapsing time the system will not currently play the selected, but rather process the new input. This avoids the system playing a portion of each item as the user navigates through the items, which enhances the user experience. In addition, this permits the user to quickly navigate through the hierarchical structure to the desired item while simultaneously receiving aural feedback.

Another application of the system may involve maintaining data regarding business contact information. The user may select information regarding the business contact to refresh his memory or otherwise obtain information. For example, while talking to Joe who represents a major software manufacturer, the user may be able to efficiently determine Joe's wife's name, without having to ask Joe for his wife's name again. Further, the system could detect the speaker and offer such information automatically to the user.

Another feature that may be included in the system is a text to speech conversion. In this manner, the title of songs or other data contained within the hierarchical menu system may be provided to the user. During use of the system the user may readily move to the top or bottom of a list of items, then move a selected number of items offset from the top or bottom to a selected item. With the permitted user interruption of the textual based speech together with its delayed presentation, a notice user learning the navigational system can listen to the cues and learn the navigation, while an experienced user using the navigational system can select an item in a quick manner. However, the experienced user may still be provided the navigational cues as the user executes “in”, “out”, and “next item” to assist in the navigation.

1. An aural user interface comprising:
(a) a hierarchical structure of data;
(b) a first input that permits the selection of a first set of data of a first level of said hierarchical structure and provides an audio output in response to said selection of said first set of data;
(c) a second input that permits the selection of a second set of data of a second level of said hierarchical structure, where said first level and said second level are different, and provides an audio output in response to said selection of said second set of data;
(d) a third input that permits the selection of one of said first set of data when said first level is selected and provides an audio output in response to said selection of one of said first set of data; and
(e) said third input permits the selection of one of said second set of data when said second level is selected and provides an audio output in response to said selection of one of said second set of data.

2. The interface of claim 1 wherein said first and second level have non-overlapping data.

3. The interface of claim 1 wherein said first input, said second input, and said third input are different buttons.

4. The interface of claim 1 wherein said audio output in response to said third input is has a variable frequency.

5. An aural user interface comprising:
(a) a hierarchical structure of data;
(b) a first input that permits the selection of a first set of data of a first level of said hierarchical structure;
(c) a second input that permits the selection of a second set of data of a second level of said hierarchical structure, where said first level and said second level are different;
(d) a third input that permits the selection of one of said first set of data when said first level is selected and provides an audio output with variable frequency in response to said selection of one of said first set of data; and
(e) said third input permits the selection of one of said second set of data when said second level is selected and provides an audio output with variable frequency in response to said selection of one of said second set of data.

6. The interface of claim 5 wherein a user can navigate between hierarchical structure to select data.

7. An aural user interface comprising:
(a) a hierarchical structure of data;
(b) a first input that permits the selection of a first set of data of a first level of said hierarchical structure and provides a first speech based audio output in response to said selection of said first set of data;
(c) a second input that permits the selection of a second set of data of a second level of said hierarchical structure, where said first level and said second level are different, and provides a second speech based audio output in response to said selection of said second set of data, where said first speech based audio output is indicative of a higher level of said hierarchical structure than said second speech based audio output;
(d) a third input that permits the selection of one of said first set of data when said first level is selected; and
(e) said third input permits the selection of one of said second set of data when said second level is selected.

8. The interface of claim 7 wherein said first speech based audio output is “in”.

9. The interface of claim 7 wherein said second speech based audio output is “out”.

10. The interface of claim 7 wherein said first speech based audio output is “next”.
